(19) United States
(12) Patent Application Publication
(10) Pub. No.: US 2011/0272363 A1
(43) Pub. Date: Nov. 10, 2011

(54) WASTE COLLECTION SYSTEM WITH BAG ASSEMBLY FORMED BY A SET OF DETACHABLE BAGS

(76) Inventor: Fernando Alberto Grazziotin, Passo Fundo (BR)

(21) Appl. No.: 13/107,475

(22) Filed: May 13, 2011

Related U.S. Application Data
(63) Continuation-in-part of application No. 10/599,206, filed on Sep. 22, 2006, now Pat. No. 7,963,698.

(30) Foreign Application Priority Data
Mar. 23, 2004 (BR) PI0400096 0

(51) Int. Cl. E03C 1/26; C02F 1/00; B23P 11/00; B65D 30/00; B65D 30/08

(52) U.S. Cl. 210/741; 4/679; 383/107; 383/109; 29/428; 210/767

(57) ABSTRACT

A waste collection system having a bag assembly, and a method for removing waste material from a waterline using the system is provided. The bag assembly includes a plurality of inner bags nested within each other to collectively form a multi-layered sidewall. The bag assembly includes at least two connectors, each connector having a first end projecting inwardly through the sidewall for attaching the bags to each other and a second end opposite the first end. A container having an inlet port and an outlet port is provided. The second end of each connector is connected to one of the ports for facilitating fluid communication through the container, wherein waste material separates from the fluid within the container and remains within an innermost bag. The innermost bag and waste material contained therein is removed from the container without disconnecting the connectors from the ports.

### CROSS-REFERENCE TO RELATED APPLICATIONS

This application is a continuation-in-part of U.S. application Ser. No. 10/599,206 filed Sep. 22, 2006, which is the U.S. national phase application of PCT Application No. PCT/BR2005/000032 filed Mar. 14, 2005, now abandoned, which, in turn, claims priority to Brazilian application Serial No. PI04000960 filed Mar. 23, 2004, the disclosures of which are incorporated in their entirety by reference herein.

### TECHNICAL FIELD

One or more embodiments relate to a waste collection system, and methods for removing waste material from a waterline using the system. The waste collection system includes a bag assembly formed by a set of multiple detachable bags set in layers, each within the subsequent ones. The set is designed to be placed in places where grit/dirt is accumulated and/or collected, both in hydraulics plants of buildings, crossover boxes, grease retainer, drains, etc. as well as in isolated places, such as trash cans and temporary toilets. It is also designed to be placed where products are placed in bags, such as those used for sorting out fruits, vegetables and other products chosen and separated by customers in supermarkets.

### BACKGROUND

Present bags found in the market and designed for the same purpose as that of the present invention are sold/supplied in single units or in multiple units, and, when multiple, are rolled up, one over the other, or piled up, also one over the other; this results in bags having to be put in place one by one. For example, patent WO 03/017807 presents a solution in which the plastic bags are laterally overlapped and have holes in their upper part so that they can be easily placed, resulting in better filling.

Some bags are simple and have one opening only in their upper end, which is the case of bags designed to be used in trash cans. Other bags may also have lateral openings, such as the bags mentioned in Letters Patent PI9801250 and C19801250, designed for use in hydraulic plants; both PI9801250 and C19801250 are Brazilian and are included in PCT Application No. PCT/BR99/00031, and U.S. Pat. No. 7,080,751.

Presently, what demands more time and poses greater difficulty for users is the placement of bags in containers. U.S. Pat. No. 4,349,123 aims at solving this problem, by introducing a collector with plastic bags overlapped within the container itself.

As to each individual bag, users have to locate and fetch the bag, not only having to take it to its destination, but also to open it and fit it in place.

Sometimes, at first, users are not sure where the openings of bags are located. Other times, although they know where the opening is located, it is difficult for users to initiate the separation of the edges of the bag so as to open it, especially when the bag walls are very pliable and thin, being, for example, 0.02 millimeters thick.

Moreover, in other cases, the handling and placement of bags results in air trapped between the walls of the bag and the walls of its container, which hinders the process of placement and accommodation of bags in containers, because, instead of flowing out of the container, the air moves internally, causing the displacement of some parts of the bag towards the opposite of where desired. The same happens whenever the bag walls are pushed towards the walls of their containers, or when the bags are put one within the other in the same container.

### SUMMARY

In at least one embodiment a waste collection system is provided. The system includes a bag assembly with a first inner bag and a second inner bag nested within the first inner bag. The bags collectively form a multi-layered sidewall with at least two apertures formed therethrough. The bag assembly also includes at least two connectors, each connector having a tubular shape with a first end and a second end opposite the first end. The first end of each connector projects inwardly through one of the apertures for attaching the bags to each other, the second end extends away from the bags. A container having a base with at least one wall extending from the base to define a chamber is provided for receiving the bag assembly. The container has an inlet port and an outlet port formed through the wall. Each port is sized for receiving the second end of one of the connectors for attaching the bag assembly to the container and for facilitating fluid communication through the system. Wherein waste material separates from the fluid within the container and remains within an innermost inner bag.

In another embodiment, a method for assembling a bag assembly is provided. A support and a plurality of inner bags that collectively form a multi-layered sidewall are also provided. Each bag has a transverse seam extending across a lower end of the bag. A first inner bag is placed over the support such that the transverse seam of the bag is oriented upon a top surface of the support. A second inner bag is placed over the first inner bag. The second inner bag is rotated such that the transverse seam of the second bag is offset relative to the transverse seam of the first bag. At least two apertures are formed through the multi-layered sidewall of the bags. At least two connectors are provided. Each connector has a tubular shape with a first end and a second end opposite the first end. The first end of each connector is inserted inwardly through one of the apertures for attaching the bags to each other.

In yet another embodiment a method for removing waste material from a waterline is provided. A bag assembly comprising a plurality of inner bags nested within each other to collectively form a multi-layered sidewall is provided. The bag assembly includes at least two connectors, each connector having a first end projecting inwardly through the sidewall for attaching the bags to each other and a second end opposite the first end. A container having an inlet port and an outlet port is also provided. Each port is formed through a wall of the container. The second end of each connector is connected to one of the ports for facilitating fluid communication through the container, wherein waste material separates from the fluid within the container and remains within an innermost bag. The innermost bag and waste material contained therein is removed from the container without disconnecting the connectors from the ports.

### BRIEF DESCRIPTION OF THE DRAWINGS

FIG. 1 is a front perspective view of a bag assembly according to at least one embodiment;

FIG. 2 is a an enlarged partial view of the bag assembly of FIG. 1;

FIG. 3 is a diagram illustrating a mounting sequence for the bag assembly of FIG. 1;

FIG. 4 is another front perspective view of the bag assembly of FIG. 1, illustrated with a folded edge;

FIG. 5 is a front perspective view of a bag assembly according to another embodiment;

FIG. 6 is an enlarged partial view of the bag assembly of FIG. 5;

FIG. 7 is an enlarged section view of the bag assembly of FIG. 5, taken along section line A-A;

FIG. 8 is an enlarged front view of a bushing of the bag assembly of FIG. 5;

FIG. 9 is a section view of the bushing of FIG. 8 taken along section line B-B;

FIG. 10 is a schematic diagram of waste collection system according to at least one embodiment, and illustrated connected to a sink and a sewer system;

FIG. 11 is a cross sectional view of the waste collection system of FIG. 10, illustrated with a bag assembly detached from a container;

FIG. 12 is an enlarged view of a connector encircled in FIG. 11;

FIG. 13 is another cross sectional view of the waste collection system of FIG. 10;

FIG. 14 is yet another cross sectional view of the waste collection system of FIG. 10, illustrated with an innermost bag in a detached position;

FIG. 15 is another cross sectional view of the waste collection system of FIG. 10, illustrated with an external bag in an attached position;

FIG. 16 is yet another cross sectional view of the waste collection system of FIG. 10, illustrated with the external bag in a detached position; and

FIG. 17 is a cross section view of a waste collection system according to another embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

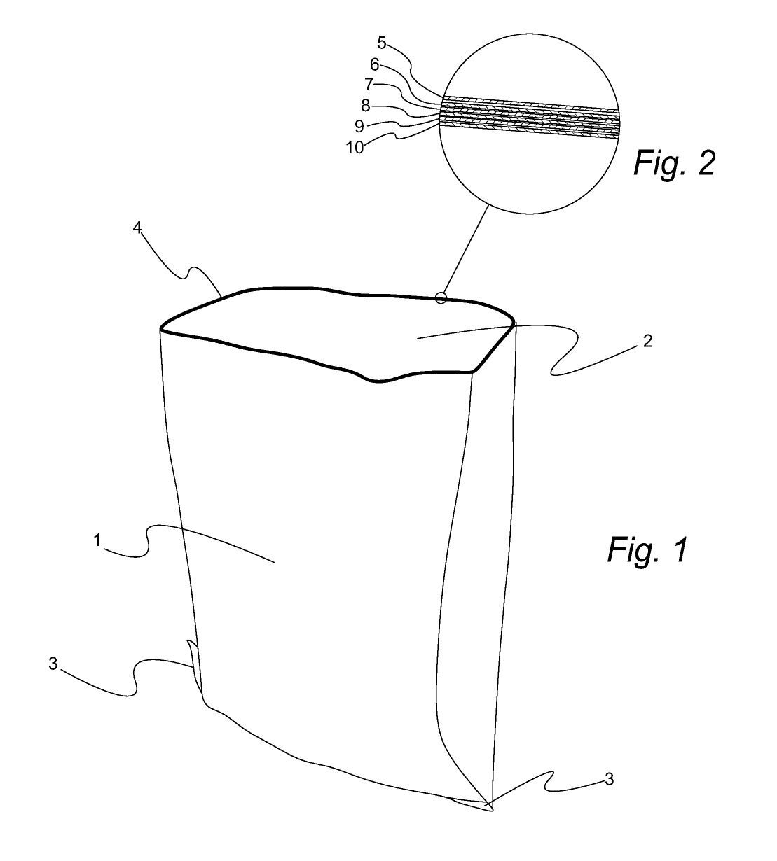

Referring to FIGS. 1 and 2, a bag assembly 1 is formed by multiple removable bags 10, 9, 8, 7, 6, 5 each one within the subsequent ones, except for the external bag 5, counting with the total or partial, if desired, expulsion of air between the bags and presenting procedures preventive of the attachment between bags in their lower extremities, so that the bag assembly 1, although used from within by means of the periodic removal of its innermost bag, maintains the quality of a single bag until it is used up.

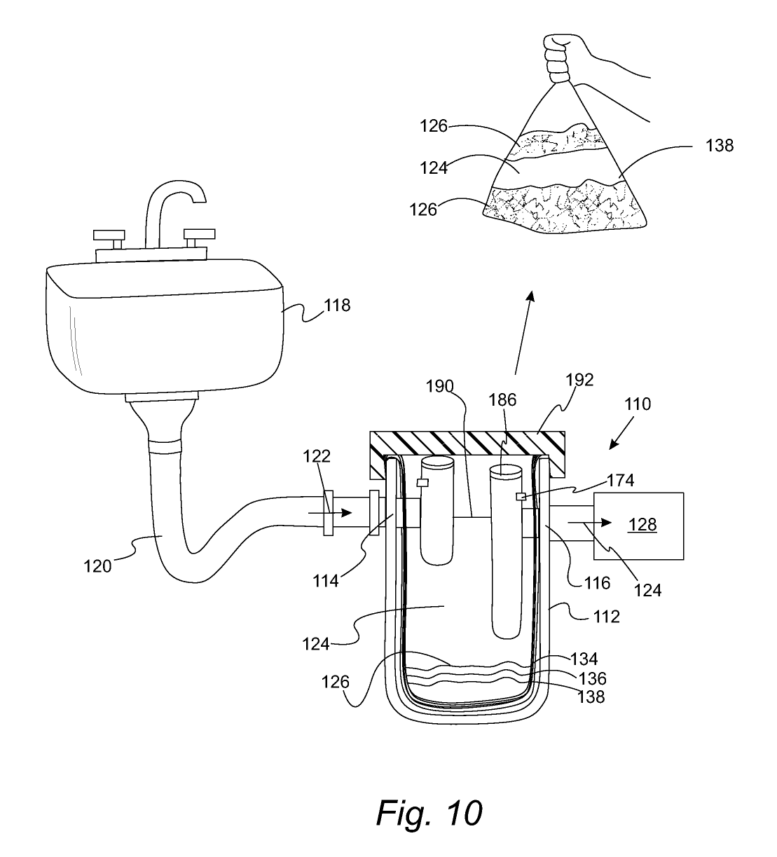

The removal of air between the bags of the bag assembly 1 is for the bag assembly 1 to have a malleability and rigidity similar to those of a bag as thick as the sum of the thickness of each individual bag of the bag assembly 1. Thus, during its placement in a container (shown in FIG. 10), when the walls of the bag assembly 1 are pushed towards the container walls, the air will flow out of the container more easily due to the greater resistance.

The bag assembly 1 is configured to allow an innermost internal bag to be removed from the bag assembly without displacing an adjacent bag. The walls of the lower end of the bag are excessive in comparison with the shape of the lower end of the container. Each bag includes projections or excesses 3 extending outwardly from the lower end of the bag. The excesses 3 of all bags are considered together, depending on the shape of the bottom of the container, folding may take place in the area of the excesses 3 and hinder the bag's removal. In order to avoid this, the bags are disposed with an alternation of a ninety degree rotation 11, which is an adequate procedure to prevent the formation of excesses 3 in the lower end of the set of bags. Another adequate procedure is the modification of the lower end of the bags before placing them one within the others, in other words, to modify the shape of the lower end, thus eliminating excesses.

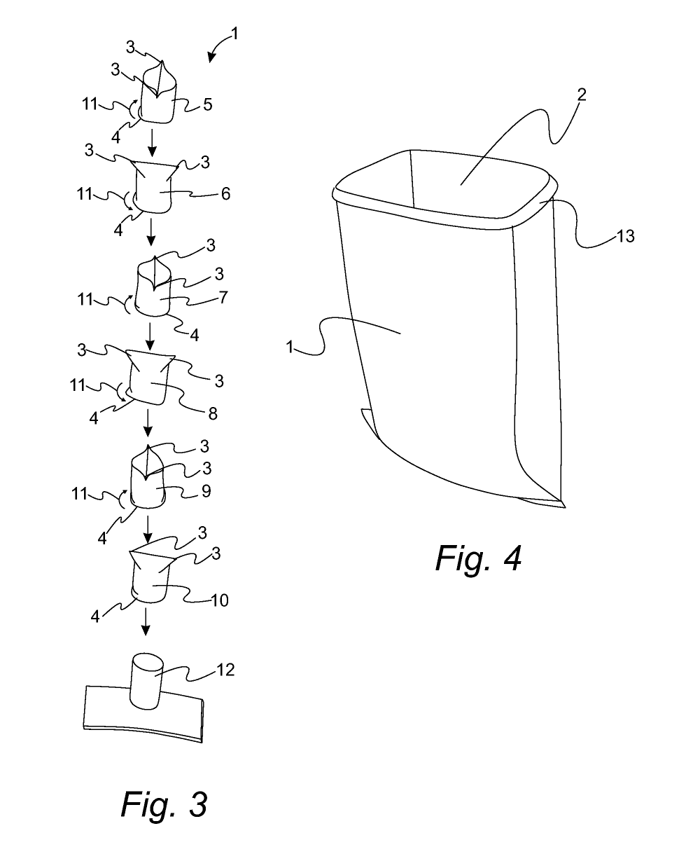

Referring to FIGS. 3 and 4, the best way to mount the bag assembly 1 is to prepare a support base 12, preferably in the shape of the interior of the container where the bag assembly 1 is to be placed, in other words, a base with external dimensions similar to the internal dimensions of the place where the bag assembly 1 will be used. The base 12 is positioned upside-down, and its height is supposed to be greater than the depth of the respective container. The base 12 will serve as a support and will occupy the inner space of the bag assembly 1 so that the air is expelled from the interior of the bags 10, 9, 8, 7, 6, 5 which will cover it.

After the support base 12 is ready, the next step is to fit the innermost internal bag 10 so that it covers the base 12. Next, considering the hypothesis that there are excesses 3 of the walls of the internal bag 10 in its lower end, which is a very common situation, the user is to cover the internal bag 10 with the second bag 9, in a position different from the previous one, so that excesses 3 do not coincide, for example, turning the second bag 9 ninety degrees 11 in relation to the position of the internal bag 10, before placing one bag over the other. Thus, the fitting of the third bag 8 is done in the same position as the innermost internal bag 10, and the fitting of the fourth bag 7 is done in the same position as the second bag 9, always alternating positions until all bags are placed and fitted one over the others. Now is the time to check for air between the bags, and if there is, to expel it. The bag assembly 1 is, then, ready. After that, in order for the bags 10, 9, 8, 7, 6, 5 of the bag assembly 1 to be more tightly together, the user folds the edge 4 of the opening 2 so as to keep the openings 2 of all subsequent 9, 8, 7, 6, 5 bags covered externally by the fold 13 of the internal bag 10. This fold 13 forces bags to be closer together, limiting the passage of air between them.

After being removed from the support base 12, the bag assembly 1 is ready to be placed in a container without a lateral opening, for example, a trash can, or ready to be folded and packaged for future use or sale. After the bag assembly 1 is placed in a trash can, the innermost internal bag 10 that was fitted in the support base will be the first bag to be detached from the bag assembly 1; the second bag 9 that was fitted in the support base will be the second to be detached, and so forth.

The advantages of the present invention, following the order of the technique presented above, are:

a) The container itself stores the bags; thus, there is no need to look for, fetch, and place each bag at a time;

b) The next bag to be used is already in place; thus, there is no need to look for the opening 2 of the bag, to open the bag, to place it inside the container, to push the walls of the bag towards the container walls, neither to adjust the upper edge of the bag to the container. Therefore, the difficulties associated to the operations just mentioned cease to exist;

c) The placement of the bag assembly 1 is easier and takes less time than the placement of only one bag at a time; the structure of the bag assembly 1 is more resistant to mild pressures, because there is very little air between the bags, which makes it easier to accommodate the walls of the bag assembly 1 to the inner walls of the container;

d) Maintenance time is reduced; and

e) There is a reduction in risks associated with inadequate body positions during longer periods of time.

When one observes the technique presently in use, one notices that, for the places mentioned in the present invention, there are no products available that are composed of multiple integrated bags for internal detachment in the handling steps.

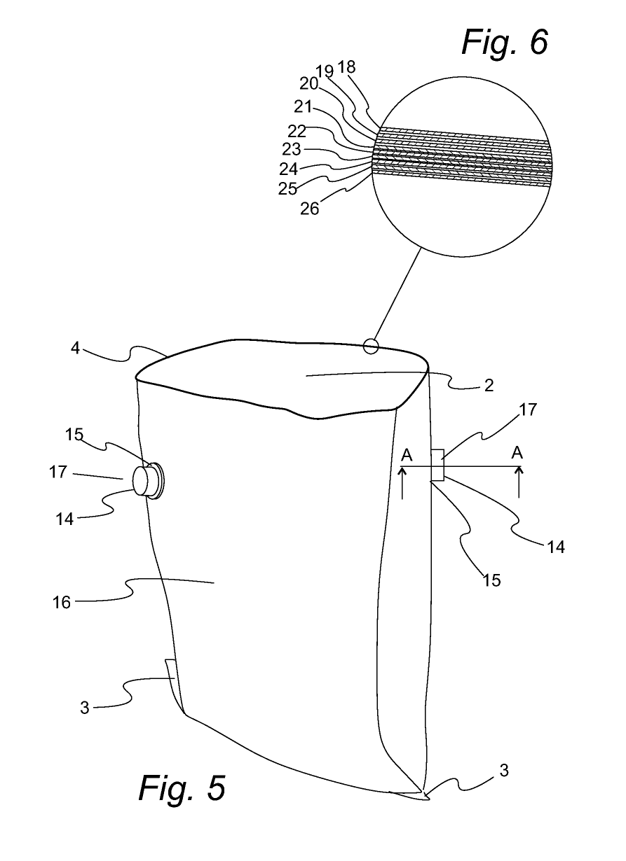

Referring to FIGS. 4 and 5, the bag assembly 1 is proper for isolated places, such as trash cans. However, when the place is part of hydraulic plants, a hydraulic plant assembly bag “HP-bag assembly” 16 must have one or more lateral-openings 17, which must have impermeable or very little permeable fittings.

That is why technologies presented in publications PI9801250, C19801250 and U.S. Pat. No. 7,080,751 exist for those cases in which bags with lateral openings are necessary.

The product of publications PI9801250, C19801250 and U.S. Pat. No. 7,080,751 presents the option of placement of multiple bags in the container, what can be done before or after the container is sold, but it does not present the solution of multiple bags previously integrated with the placement in the container.

One problem resulting from the use of prior art technologies has to do with the fitting of lateral openings of the HP-bag assembly 16, since the thickness of its walls is much greater than the thickness of each bag that comprises it, hindering manual fitting because it demands much physical effort or a fitting done individually per bag.

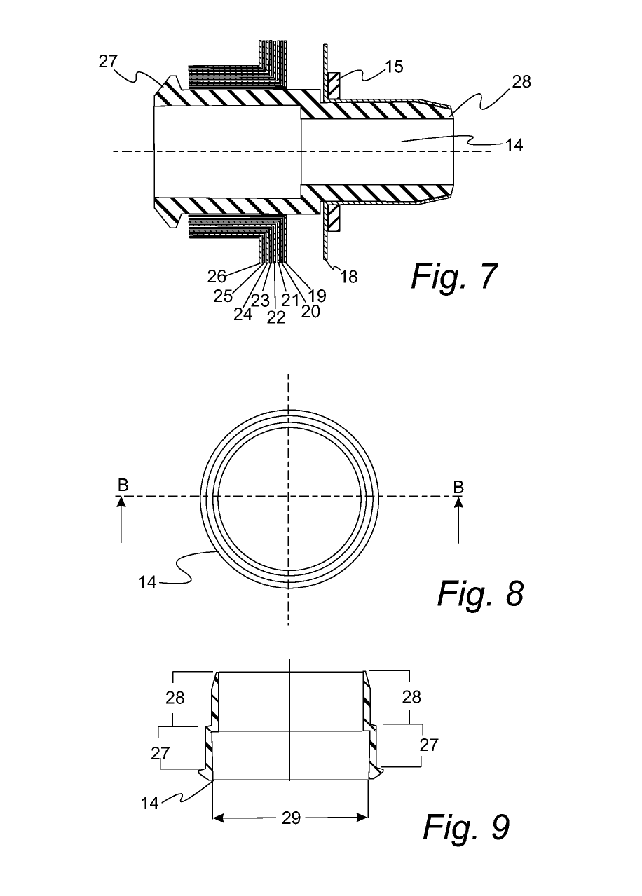

Referring to FIGS. 5-9, a bushing 14 with two fitting regions: a first fitting region 27, and a second fitting region 28 is provided. The second fitting region 28 is used for fitting and sealing between the HP-bag assembly 16 and the container, which can serve for the fitting of one external bag 18, resulting in the type of sealing mentioned in C19801250 and the first fitting region 27 is used for fitting in the respective lateral opening of the HP-bag assembly 16 in order to promote sealing when liquids flow from the more central bag to any of the subsequent bags of the HP-bag assembly 16, by means of the technique mentioned in PI9801250.

The advantage brought by the creation of the bushing 14 is exactly to enable the integration of previous technologies with that of the bag formed by the removable bags, so as to allow its use in hydraulic plants.

A single device, i.e., the bushing 14, intermediates two types of connections: one between the inner layers of the HP-bag assembly 16, and another between the external HP-bag 18 and the container.

More steps for the setting up of the HP-bag assembly 16 will be necessary if the container has lateral-openings 17. In order to prepare each lateral-opening 17 of the HP-bag assembly 16, the user has to make a circular-opening in the HP-bag assembly 16, one whose diameter is smaller than the diameter of the corresponding first fitting region 27 of the bushing 14 to be placed.

Before the introduction of the bushing 14 into the circular-opening of the HP-bag assembly 16, one needs to make the edge of the circular-opening to work similarly to a rigid flat ring 15; this can be accomplished by pushing the walls of the bags of the HP-bag assembly 16 into a circumference of greater radius than the initial radius of the circular opening mentioned.

The next step is to move onwards an element that penetrates into the circular opening mentioned, following the direction of an axis perpendicular to the rigid flat ring 15, forcing the walls, generating internal tensions, so that the ring changes from flat to the shape of the base of a cone, i.e., the shape of the element mentioned.

Along with the element mentioned, the bushing 14 is moved so that it penetrates into the same opening, until all the opening is positioned in the first fitting region 27 of the bushing 14; as a result the opening no longer has the cone-base shape; now it has a cylindrical shape, which is the external shape of the bushing 14 where fitting takes place.

Considering the second fitting region 28 of the bushing 14, an external HP-bag 18 is positioned externally to the other HP-bags 19, 20, 21, 22, 23, 24, 25, 26. In each lateral-opening 17 of this external HP-bag 18, the end of the respective bushing 14 is fitted and will serve to connect the HP-bag assembly 16 to the container, allowing for a better sealing in the connection. In order to assure that the external HP-bag 18 will not get loose, a ring 15 is placed to fix it in place.

Since sometimes containers have internal parts, for example, a trap connected to the outlet, the bushing 14 has in its end opposite to the insertion in inlet or outlet of container, an internal diameter 29 that is equal to the internal diameter of the inlet or outlet of the container, so that, for example, the trap may be connected to the bushing instead of to the container.

Certainly, as it is clear for any expert in the field, the ways to represent the invention are not limited to the examples mentioned above and may vary according to the scope of claims attached. The mounting of the set of bags presented herein may be done manually or automatically.

Referring to FIG. 10, a waste collection system for removing waste material from a waterline is illustrated in accordance with an embodiment and is generally referenced by numeral 110. The system 110 includes a container 112 with an inlet port 114 and an outlet port 116. A sink 118 is connected to the inlet port 114 by a sink discharge pipe 120. The sink 118 receives waste fluid 122 and the fluid 122 flows through the pipe 120 to the system 110. The waste fluid 122 includes water 124 and waste material 126, such as food particles, fats, oils and greases. A sewer system 128 is connected to outlet port 116 by an outlet pipe 130. The waste material 126 may clog or damage the sewer system 128. Therefore the system 110 separates the waste material 126 from the waste fluid 122, and allows the water 124 to flow through the outlet pipe 130 to the sewer system 128. The waste collection system 110 retains the waste material 126 within the container 112. The container 112 has a limited capacity for storing the waste material 126 and must be cleaned regularly. Other embodiments of the system 110 contemplate connection to other sources of waste fluid, such as dishwashers and temporary toilets.

The waste collection system 110 allows for efficient removal of the waste material 126. The waste collection system 110 includes a bag assembly 132 for lining an interior portion of the container 112. The bag assembly 132 includes a first inner bag 134 and a plurality of inner bags 136 nested within the first inner bag 134. The waste fluid 122 flows into an innermost bag 138. The waste material 126 accumulate within the innermost bag 138 as the water 124 flows through the system 110. The innermost bag 138 is detached from the remaining inner bags 134, 136 and removed from the system 110 along with any accumulated waste material 126.

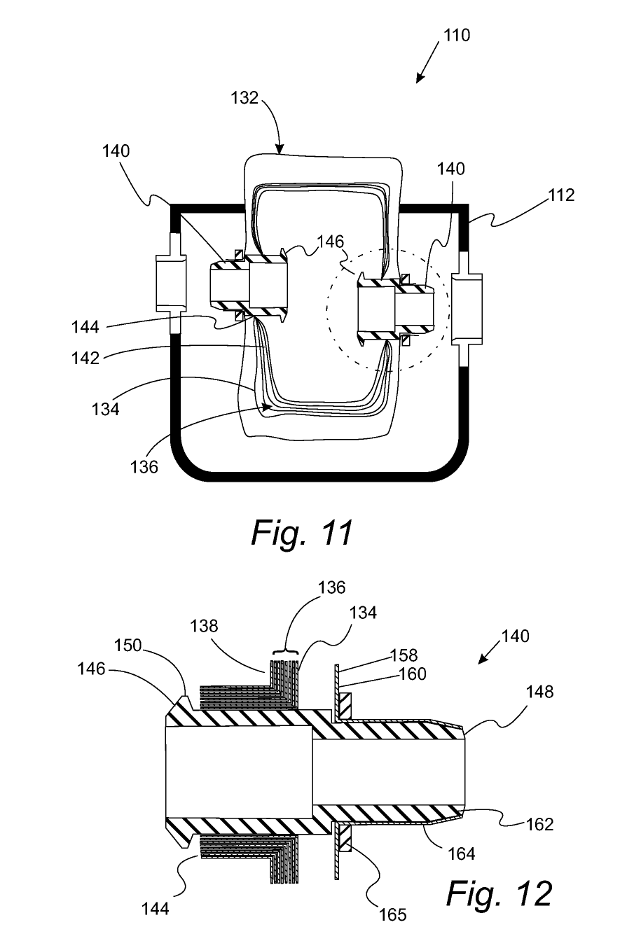

With reference to FIGS. 11 and 12, the system 110 includes a pair connectors 140 for attaching the inner bags 134, 136 to each other. The inner bags 134, 136 collectively form a multi-layered sidewall 142. A pair of apertures 144 are formed through the sidewall 142. Each connector 140 has a tubular shape with a first end 146 and a second end 148 oriented opposite to the first end 146. The first end 146 of each connector 140 projects through one of the apertures 144 formed in the multi-layered sidewall 142. The outer diameter of the first end 146 is larger than the corresponding inner diameter of the aperture 144 for providing an interference fit. This interference fit helps retain the inner bags 134, 136 to the first end 146. The second end 148 of the connector 140 extends away from the inner bags 134, 136. A lip 150 extends radially outward from an inner edge of each first end 146 for further retaining the bags 134, 136, according to one embodiment. Other embodiments of the system 110 contemplate one connector 140 or more than two connectors 140 depending on the number of ports formed into the container 112.

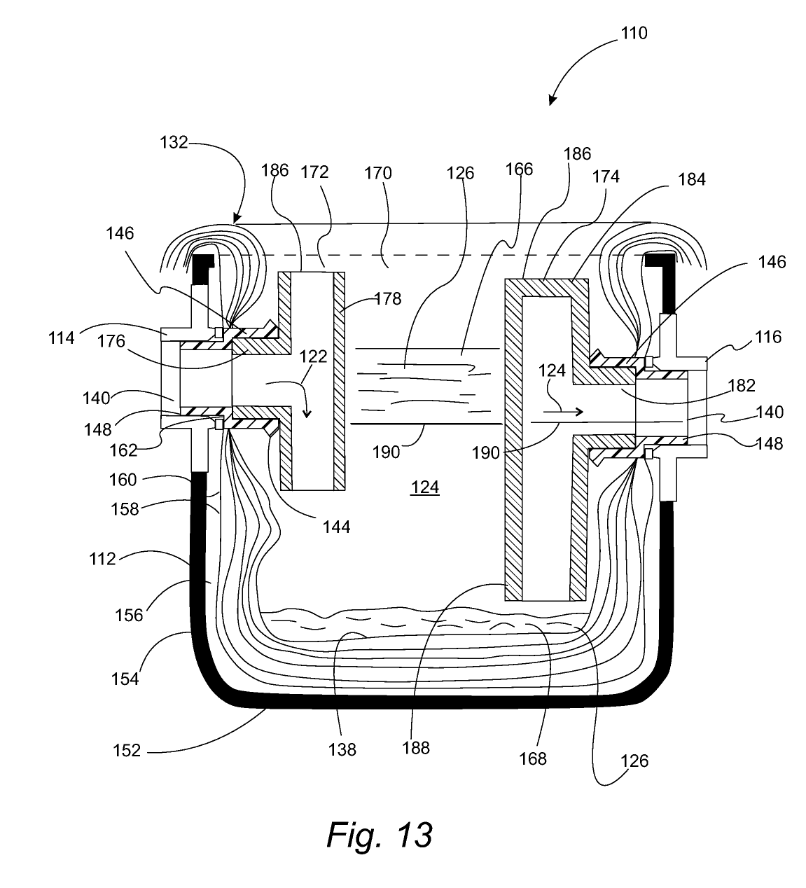

Referring to FIGS. 12 and 13, the connectors 140 also attach the bag assembly 132 to the container 112. The container 112 includes a base 152 with a wall 154 extending upward from the base 152. The base 152 and wall 154 form a chamber 156 for receiving the bag assembly 132. The inlet port 114 and the outlet port 116 are formed through the wall 154 for facilitating fluid communication through the system 110. Each port 114, 116 receives the second end 148 of one of the connectors 140 for attaching the bag assembly 132 to the container 112.

The waste collection system 110 includes an external bag 158 for sealing the bag assembly 132 to the container 112, according to one embodiment. The external bag 158 receives the inner bags 134, 136. The external bag 158 includes a sidewall 160 with at least two apertures 162 formed through the sidewall 160. The apertures 162 of the external bag 158 are aligned with the apertures 144 of the inner bags 134, 136. The second end 148 of each connector 140 projects through one of the apertures 162 of the external bag 158. The outer diameter of the second end 148 is larger than the corresponding inner diameter of the aperture 162 of the external bag 158 for providing an interference fit. This interference fit helps retain the external bag 158 to the second end 148. The sidewall 160 deforms as the second end 148 projects through the aperture 162, and a deformed portion 164 of the sidewall 160 extends over the second end 148 of the connector 140. (Shown in FIG. 12). The system 110 may also include a ring 165 that slides over the second end 148 and the deformed portion 164 for further securing the external bag 158 to the connector 140. The deformed portion 164 of the external bag 158 is compressed between the second end 148 of the connector 140 and an inner surface of the port 114, 116 to provide a seal. This seal prevents waste material 126 from transferring from within the bag assembly 132 to the inside of the container 112.

With reference to FIG. 13, the waste collection system 110 utilizes gravity for separating the waste material 126 from the water 124. Waste material 126 having different density than water 124 separates within the chamber 156. Low density waste material 166, such as oils and grease, rise above the water 124 within the chamber 156. High density material 168, such as food particles, sink to the bottom of the chamber 156. The inlet port 114 and the outlet port 116 are formed through the wall 154 at an intermediate portion of the chamber 156. An air pocket 170 is created within an upper portion of the chamber 156 for regulating internal air pressure within the container 112.

The waste collection system 110 includes an inlet trap 172 and an outlet trap 174 for facilitating the separation of the waste material 126 from the water 124 within the chamber 156. The inlet trap 172 is coupled to the inlet port 114 by one of the connectors 140. The inlet trap 172 includes a side tube 176 that is received within the first end 146 of one of the connectors 140. An upright tube 178 extends transversely from the side tube 176. An upper end of the upright tube 178 extends into the air pocket 170. An air vent 180 is formed into the upper end of the upright tube 178 for regulating internal air pressure within the system 110. Waste fluid 122 is received through the inlet port 114 and flows through an opening formed into a lower end of the upright tube 178.

The outlet trap 174 is coupled to the outlet port 116 by one of the connectors 140. The outlet trap 174 includes a side tube 182 that is received within the first end 146 of one of the connectors 140. An upright tube 184 extends transversely from the side tube 182. An upper end 186 of the upright tube 184 extends into the air pocket 170, and includes a closed top surface. However, an opening (not shown) may be formed into the upper end 186 if needed for regulating air pressure. A lower end 188 of the upright tube 184 is positioned within an intermediate portion of the chamber 156 and includes an opening for receiving the water 124.

The size of the container 112 and the length of the upright tubes 178, 184 determines the capacity of the system 110 for storing waste material 126. The top of the layer of water 124 (watersurface) within the container 112 is generally referenced by numeral 190 in FIG. 13. The height of the watersurface 190 aligns with the opening of the outlet port 116 when the internal pressure within the system 110 is property regulated. The distance between the watersurface 190 and the air vent 180 of the inlet trap defines the amount of low density waste material 166 that the system 110 can hold. Once the low density waste material 166 accumulates enough to flow into the air vent 180, then the waste material 166 will restrict the flow of waste fluid 122 into the system 110. The distance between the lower end 188 of the outlet trap 174 and the bottom of the innermost bag 138 defines the amount of high density waste material 168 that the system 110 can hold. Once the high density waste material 168 accumulates enough to contact the lower end 188, then the material 168 will block the flow of water 124 out of the system 110.

FIGS. 10-16, illustrate a method for removing waste material 126 from a waterline using a waste collection system 110, according to at least one embodiment. Referring to FIG. 11, first the bag assembly 132 is provided. The bag assembly 132 is assembled according to the procedure described with reference to FIG. 3, according to one embodiment. The bag assembly 132 is then placed within the container 112.

Next the bag assembly 132 is attached to the container 112 as shown in FIG. 13. The second end 148 of one connector 140 is connected to the inlet port 114, and the second end 148 of another connector 140 is connected to the outlet port 116 for facilitating fluid communication through the system 110. An upper edge of each bag 134, 136, 158 is folded over the top of the container 112. The inlet trap 172 is connected to the first end 146 of one of the connectors 140. The outlet trap 174 is connected to the first end 146 of another connector 140.

Referring back to FIG. 10, the system 110 is then connected to the waterline. The inlet port 114 is connected to the sink discharge pipe 120, and the outlet port 116 is connected to the outlet pipe 130. The system 110 is pre-filled with water 124 until the watersurface 190 rises to the height of the outlet port 116. A lid 192 is secured to the top of the container 112. A liner (not shown) may be disposed over the top of the container 112 to create a waterproof seal between the container 112 and the lid 192.

The system 110 may be evaluated for proper internal air pressure regulation prior to use. First, the sink 118 is filled with water 124; then the sink is drained. After the sink 118 drains, the lid 192 is removed from the container 112 to check the height of the watersurface 190. If the watersurface 190 is lower than the outlet port 116, then this indicates that the internal air pressure is not properly regulated. For example, a low watersurface 190 may indicate that high internal air pressures are present within the container 112 which may result in some of the waste material 126 being carried through the system 110. To adjust the air pressure, an opening is made to the upper end 186 of the outlet trap 174.

FIG. 13 illustrates operation of the system 110 where the waste fluid 122 flows into the system 110, and waste material 166, 168 accumulates within the innermost bag 138.

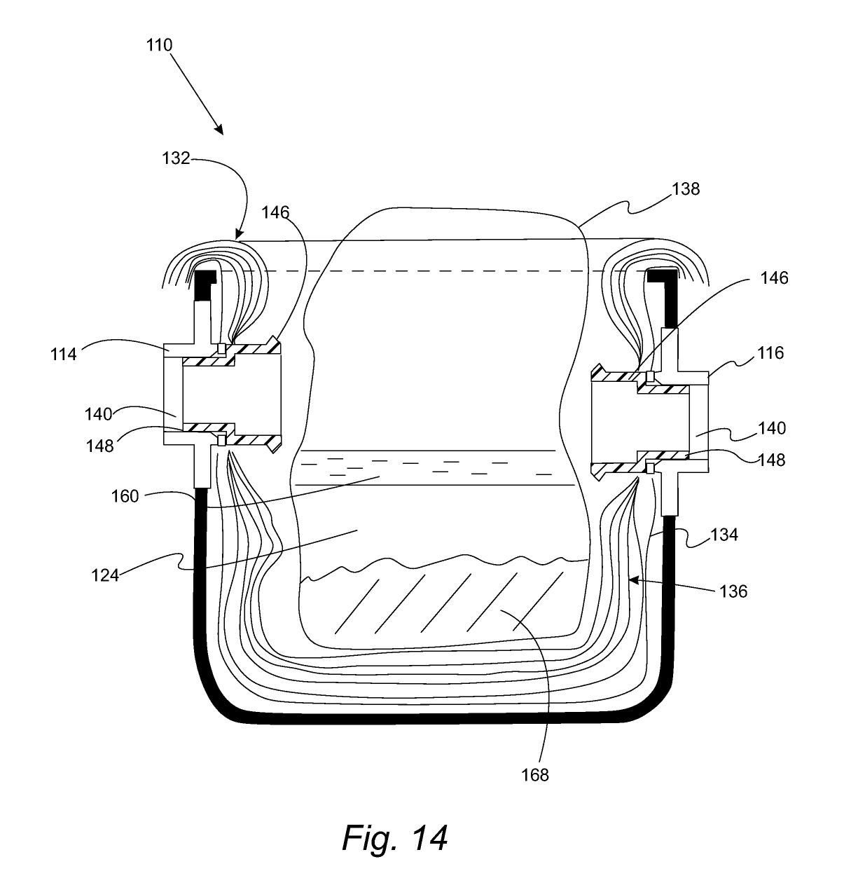

Next, an innermost bag 138 and any accumulated waste material 166, 168 is removed from the system, as illustrated in FIG. 14. To remove the waste material 166, 168; first the inlet trap 172 and the outlet trap 174 are disconnected from the connectors 140. Next, the innermost bag 138 is pulled inward to detach the bag 138 from the first end 146 of each connector 140. The nesting of the bags 134, 136 allows for the innermost bag 138 to be removed individually, without detaching an adjacent bag from the connector 140. Additionally, the connectors 140 remain connected to the inlet port 114 and the outlet port 116 for maintaining the seal between the external bag 158 and the container 112 which prevents waste material 126 from inadvertently spilling into the container during cleaning. The process of removing the innermost bag 138 without disconnecting the connectors 140 is repeated until all of the inner bags 134, 136 are removed.

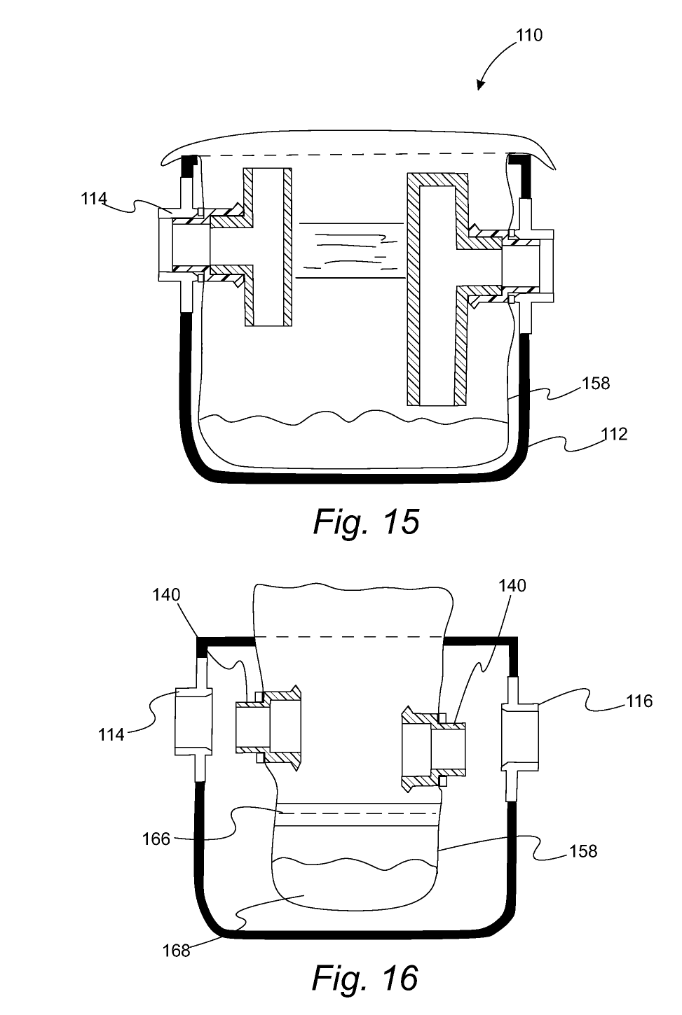

FIG. 15 depicts the waste collection system 110 after all of the inner bags 134, 136 have been removed, and only the external bag 158 remains connected to the container 112. In FIG. 16, the connectors 140 are disconnected from the ports 114, 116 to remove the external bag 158 and any accumulated waste material 166, 168. Once all of the bags, inner 134, 136 and external 158 are removed, the user acquires a new bag assembly 132 and attaches it to the container 112 as described above with reference to FIG. 11.

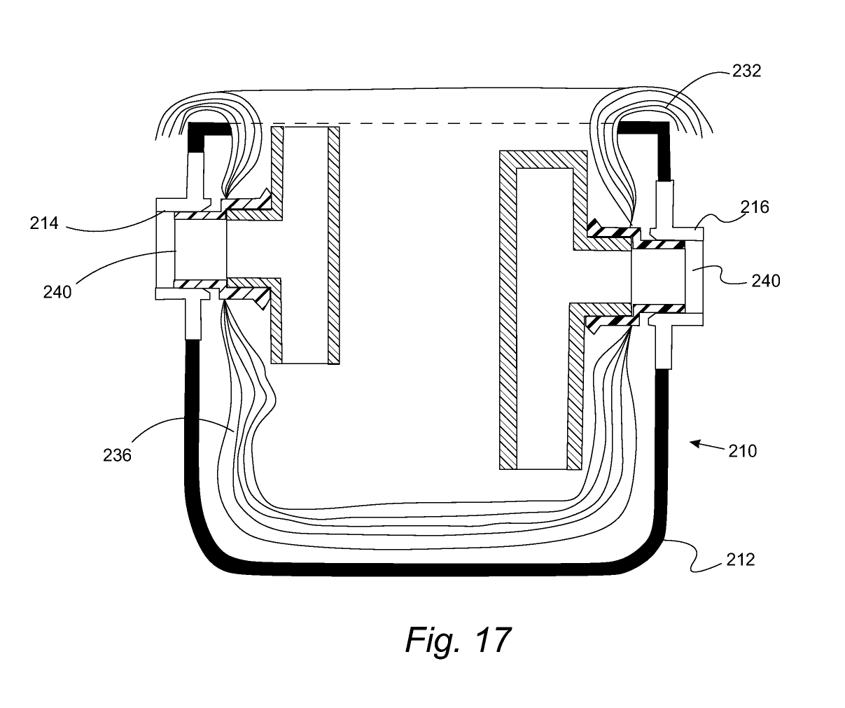

Referring to FIG. 17, a waste collection system in accordance with another embodiment is illustrated and is generally referenced by numeral 210. The waste collection system 210 of this embodiment does not include an external bag. The system 210 includes a container 212 with an inlet port 214 and an outlet port 216. The system 210 also includes a bag assembly 232 with a plurality of inner bags 236 and a pair of connectors 240 that project through the inner bags 236 for attaching the bag assembly 232 to the container 212. An innermost inner bag 236 is selectively removed from the system 210, without disconnecting the connectors 240 from the ports 214, 216 or disturbing an adjacent bag. Once the last inner bag 236 is removed from the system 210, the connectors 240 may be disconnected from the ports 214, 216 and a new bag assembly 232 is attached to the container 212.

While embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A waste collection system comprising:
a bag assembly provided with:
a first inner bag and a second inner bag nested within the first inner bag, the bags collectively forming a multi-layered sidewall with at least two apertures formed therethrough, and
at least two connectors, each connector having a tubular shape with a first end and a second end opposite the first end, the first end of each connector projecting inwardly through one of the apertures for attaching the bags to each other, the second end extending away from the bags; and
a container having a base with at least one wall extending from the base to define a chamber for receiving the bag assembly, the container having an inlet port and an outlet port formed through the wall, each port being sized for receiving the second end of one of the connectors for attaching the bag assembly to the container and for facilitating fluid communication through the system, wherein waste material separates from the fluid within the container and remains within an innermost inner bag.

2. The system of claim 1 wherein each inner bag further comprises a seam extending transversely across a lower end of the bag, the seam forming at least one projection extending outwardly from the lower end, wherein each bag is nested at an offset orientation of each seam relative to the seam of an adjacent inner bag for allowing the innermost inner bag and any collected waster material to be selectively removed from the system without displacing the adjacent bag.

3. The system of claim 1 wherein the bag assembly further comprises an external bag for receiving the inner bags therein, the external bag having a sidewall with at least two apertures formed through the sidewall, wherein the second end of each connector projects outwardly through one of the apertures of the external bag.

4. The system of claim 3 wherein a portion of the sidewall of the external bag extends over the second end of the connector and is compressed between the second end and the port for forming a seal between the external bag and the container.

5. The system of claim 3 further comprising a ring disposed over the second end of the connector for retaining the external bag to the connector.

6. The system of claim 1 further comprising a trap with an upright tube and a side tube extending transversely from the upright tube, the side tube being connecting to the first end of one of the connectors, wherein the connector couples the trap to one of the inlet port and the outlet port for facilitating fluid communication through the system.

7. The system of claim 6 wherein the upright tube extends into an air pocket within the container and has an opening formed therein for providing an air vent.

8. A method for assembling the bag assembly of claim 1, the method comprising:
providing a support having a cylindrical shape;
placing the first inner bag over the support such that a transverse seam extending across a lower end of the bag is oriented upon a top surface of the support;
placing the second inner bag over the first inner bag;
rotating the second inner bag so that a transverse seam of the second bag is offset relative to the transverse seam of the first bag;
forming the at least two apertures through the multi-layered sidewall of the bags; and
inserting the first end of each connector through one of the apertures for attaching the bags to each other.

9. The method of claim 8 further comprising:
placing the bag assembly within the container; and
connecting the second end of each connector to one of the inlet and outlet ports for facilitating fluid communication through the container.

10. A method for removing waste material from a waterline, the method comprising:
providing a waste collection system according to claim 1;
removing the innermost bag and any waste material accumulated therein from the container without disconnecting the connectors from the inlet and outlet ports.

11. A method for assembling a bag assembly, the method comprising:
providing a support having a cylindrical shape;
providing a plurality of inner bags, the bags collectively forming a multi-layered sidewall, each bag having a transverse seam extending across a lower end of the bag;
placing a first inner bag over the support such that the transverse seam of the bag is oriented upon a top surface of the support;
placing a second inner bag over the first inner bag;
rotating the second inner bag so that the transverse seam of the second bag is offset relative to the transverse seam of the first bag;
forming at least two apertures through the multi-layered sidewall of the bags;
providing at least two connectors, each connector having a tubular shape with a first end and a second end opposite the first end; and
inserting the first end of each connector inwardly through one of the apertures for attaching the bags to each other.

12. The method of claim 11 further comprising:
providing an external bag having a sidewall with at least two apertures formed through the sidewall;
placing the external bag over the inner bags; and
inserting the second end of each connector outwardly through one of the apertures of the external bag.

13. The method of claim 12 further comprising:
providing at least one ring; and
disposing the ring over the second end of one of the connectors for retaining the external bag to the connector.

14. The method of claim 11 further comprising compressing the multi-layered sidewall against the support for expelling any air collected between adjacent bags; and
folding an edge of the multi-layered sidewall over itself to form a fold for preventing air from collecting between the adjacent bags.

15. A method for removing waste material from a waterline, the method comprising:
providing a bag assembly comprising a plurality of inner bags nested within each other to collectively form a multi-layered sidewall and at least two connectors each having a first end projecting inwardly through the sidewall for attaching the bags to each other and a second end opposite the first end;
providing a container having an inlet port and an outlet port, each port being formed through a wall of the container;
connecting the second end of each connector to one of the ports for facilitating fluid communication through the container, wherein waste material separates from the fluid within the container and remains within an innermost bag; and
removing the innermost bag and waste material contained therein from the container without disconnecting the connectors from the ports.

16. The method of claim 15 further comprising:
providing an external bag;
nesting the inner bags within the external bag; and
inserting the second end of each connector through the external bag.

17. The method of claim 16 further comprising:
providing a ring; and
inserting the second end of one of the connectors through the ring for retaining the external bag to the connector.

18. The method of claim 15 further comprising:
providing an inlet trap and an outlet trap;
coupling the inlet trap to the inlet port by connecting the inlet trap to the corresponding connector; and
coupling the outlet trap to the outlet port by connecting the outlet trap to the corresponding connector.

19. The method of 18 further comprising evaluating the performance of the internal air pressure regulation of the system by comparing a distance between a water surface contained within the innermost bag to a height of the outlet port.

20. The method of claim 19 further comprising forming an opening in an upper end of the outlet trap in response to the performance of the internal air pressure regulation.
